(19) United States
(12) Patent Application Publication
(10) Pub. No.: US 2025/0151650 A1
(43) Pub. Date: May 15, 2025

(54) Fruit Picking Device with Tacky Gripping Surface

(71) Applicant: JAMES GORDON POWERS, PAHOA, HI (US)

(72) Inventor: JAMES GORDON POWERS, PAHOA, HI (US)

(21) Appl. No.: 18/900,819

(22) Filed: Sep. 29, 2024

(51) Int. Cl. A01D 46/247

(52) U.S. Cl. CPC A01D 46/247

(57) ABSTRACT

The invention is a harvesting device designed to minimize damage to produce during harvesting. It features a conical-cylindrical receptacle with a tacky, flexible gripping surface that conforms to the shape of various fruits and produce, allowing gentle and secure handling. The gripping surface enables the produce to be twisted off from the stem without bruising. The device also includes a threaded base compatible with standard extension poles for easy attachment, providing adaptability to different harvesting conditions.

### CROSS-REFERENCE TO RELATED APPLICATIONS

This application claims the benefit of U.S. Provisional Application No. 63/629,211, filed on Oct. 2, 2023, the entire content of which is incorporated herein by reference.

### SUMMARY AND TRANSITION FROM PROVISIONAL TO NONPROVISIONAL DISCLOSURE

This nonprovisional application builds upon and clarifies the original invention disclosed in the provisional application. The core invention, as outlined in the provisional, consists of a cone-shaped device with a soft, tacky interior surface for gently gripping and detaching produce from a tree. It is designed to be attached to an extension pole for harvesting fruits that are out of reach.

In this nonprovisional application, the term “cone-shaped device” is clarified as a conical-cylindrical hybrid receptacle. This updated terminology aligns with the shape shown in illustration #2 of the provisional application, which displays a receptacle with cylindrical sections connected by a curved conical transition. All references to the “conical-cylindrical hybrid shape” are intended to elaborate upon and provide a more detailed understanding of the cone shape originally disclosed.

The improvements and enhancements introduced in this nonprovisional application build upon the core invention by including features such as modular inserts and attachments, which adapt the receptacle's internal dimensions to accommodate different sizes and types of produce. Additionally, the receptacle is constructed from Shore A 60-70 silicone rubber, selected and refined through testing to achieve optimal tackiness and flexibility. The layered structure consists of silicone-fabric-silicone layers, enhancing the receptacle's durability and providing rip-stop characteristics. Furthermore, the threaded base is specifically designed for compatibility with standard extension poles, incorporating sharp points for secure attachment and a longer length to improve stability.

These enhancements maintain the original functionality of the invention while improving its adaptability and versatility. All features and descriptions provided are consistent with the original invention as disclosed in the provisional application, with the nonprovisional application offering additional details and refinements to support broader applicability.

### STATEMENT REGARDING PRIOR DISCLOSURES BY THE INVENTOR

After the Provisional Application was filed on Oct. 2, 2023, the inventor began offering the “core invention (as described in the provisional application) for sale to the public at a Farmers' Market in Hawaii using the product name the “Perfect Purple Picker”. The inventor also published the core invention on the internet on an Etsy site (https://www.etsy.com/listing/1559458646), for sale and created a website (www.purfectpurplepicker.com). The core invention was advertised in a weekly newsletter publication called Puna Happenings and referenced in various Facebook postings and was also sold through retail stores in Hawaii and Oregon.

### BACKGROUND OF THE INVENTION

### Field of the Invention

The present invention relates to an advanced fruit-picking device designed for use in agricultural and horticultural applications. It addresses the need for a picking tool that minimizes damage to delicate fruits while offering adaptability to various sizes and harvesting conditions. The invention incorporates a unique combination of silicone rubber, a conical-cylindrical hybrid receptacle design, and modular attachments, providing a novel solution to challenges faced by current picking devices.

### Description of Prior Art

A variety of fruit-picking devices have been developed for agricultural and horticultural use. While each offers partial solutions to the challenges of harvesting delicate produce, most fail to provide an effective balance between gentle handling and harvesting efficiency. Common limitations in existing devices include damage to fruits due to rigid or abrasive gripping mechanisms, entanglement in branches, and limited adaptability to fruits of varying sizes and types. The core invention, as disclosed in the provisional application, seeks to overcome these shortcomings with a cone-shaped device with a soft tacky surface, ensuring efficient and gentle harvesting. Further refinements and improvements detailed in this nonprovisional application enhance the adaptability and functionality of the invention beyond the solutions described in the following prior art references.

U.S. Pat. No. 898,696 (1908-Southworth)-Electric Light Bulb Changer: Southworth's device is designed for gripping incandescent light bulbs using an elastic cylindrical rubber rim with longitudinal corrugations. The purpose is to firmly hold smooth glass bulbs without causing damage during installation or removal. In contrast, the core invention disclosed in the provisional application uses soft, tacky silicone rubber, providing a gentle yet effective grip for harvesting delicate fruits, such as papayas, without bruising. The tacky interior surface of the conical-cylindrical hybrid receptacle cradles and twists fruit stems gently, which is fundamentally different from Southworth's focus on gripping a rigid, smooth bulb.

U.S. Pat. No. 734,033 (1903-Alden)-Fruit Picker: Alden's fruit picker consists of a rigid cylindrical sleeve with curved arms that extend outward to sever fruit from branches. While suitable for handling harder fruits, the device does not provide the necessary flexibility or gentle grip for delicate fruits, such as papayas. The core invention disclosed in the provisional application addresses these limitations by using a conical-cylindrical hybrid shape made of soft, tacky silicone rubber, which gently grips and twists fruit from the stem without damage. Additionally, the cylindrical sections of the core invention prevent entanglement with branches and allow for easier maneuverability, making it more versatile than Alden's design.

U.S. Pat. No. 3,397,526 (1968-Barrow)-Fruit Picker: Barrow's device is centered around using a cutting blade to sever fruit from the stem and a storage enclosure to collect the cut fruit. This design emphasizes a cutting action rather than a gentle gripping motion, making it unsuitable for handling delicate fruits. In contrast, the core invention disclosed in the provisional application uses a conical-cylindrical hybrid design with a soft, tacky silicone rubber surface to gently grip and twist the fruit off the stem. This approach preserves the fruit's integrity and allows for damage-free harvesting, distinguishing it from the cutting mechanism in Barrow's picker.

U.K. Patent Application GB2234417A (1991-Spalding)-Fruit Picking Apparatus: Spalding's invention discloses a frusto-conical receptacle with an internal spiral rib to grip and twist fruit for detachment. While this design provides a method for picking fruit, it lacks the tacky silicone gripping surface disclosed in the core invention of the provisional application. Instead of relying on an internal rib for grip, the soft Shore A 70 silicone rubber in your invention conforms to the fruit's surface, providing a gentle grip that minimizes damage during the twisting action. Furthermore, the conical-cylindrical hybrid shape enables efficient handling and adaptability to various fruit sizes, setting it apart from Spalding's rigid spiral structure.

U.S. Pat. No. 5,440,867 (1995-Strus)-Fruit Picking Device: Strus's device comprises a conical receptacle with a rubberized foam interior, designed to frictionally grip the fruit through compressibility and resilience. The foam material aims to engage the fruit and facilitate twisting for detachment. In contrast, the core invention disclosed in the provisional application employs a soft, tacky silicone surface to grip and twist fruit stems. This approach does not rely on the compressibility of foam but rather on the tackiness and elasticity of silicone, providing a gentle yet effective grip that conforms to the fruit's shape, thereby minimizing damage. The conical-cylindrical hybrid design further supports a broad range of fruit sizes and enables smooth twisting action without requiring a change in the receptacle structure.

U.S. Patent Application US20150296710A1 (2015-Tia)-Fruit Collecting Device: Tia's invention employs a cage with serrated edges designed to cut the stems of fruit, allowing the fruit to fall into the cage for collection. This mechanism focuses on cutting and storage, whereas the core invention disclosed in the provisional application utilizes a soft, tacky silicone rubber surface to gently grip and twist fruit from the stem without damaging it. The conical-cylindrical hybrid shape in your invention provides a more controlled detachment process, maintaining the integrity of the fruit by avoiding cutting actions.

U.S. Patent Application US20210185924A1 (2021-Moufawad)-Fruit Picker and Branch Trimmer: Moufawad's invention features rotating jaws triggered by contact with stems, branches, or the fruit itself to exert a perpendicular force, severing the stem or branch. This cutting action contrasts with the core invention described in the provisional application, which uses a soft, tacky silicone surface to gently grip and twist produce from its stem, avoiding the need for cutting and thus preserving the integrity of delicate fruits. The conical-cylindrical hybrid design of your invention supports the efficient, damage-free harvesting of a wide range of fruit sizes, setting it apart from the cutting-focused mechanism of the Moufawad device.

### SUMMARY OF THE INVENTION

The present invention introduces a novel approach to fruit picking by focusing on gentle handling and adaptability. The core invention, as disclosed in the provisional application, is a conical-cylindrical hybrid receptacle made of silicone rubber. This unique soft, tacky gripping surface provides a secure yet damage-free grip on various fruits, ensuring efficient harvesting without bruising or tearing. The conical-cylindrical design enables the receptacle to cradle fruits of different shapes and sizes, and the twisting motion facilitates detachment from stems in a way that preserves the integrity of the produce.

The improvements introduced in the nonprovisional application build upon this core design to enhance its versatility and usability. These include:

Modular inserts that nest within the receptacle, allowing size customization for smaller or uniquely shaped fruits.

The use of a layered silicone construction with a fabric core to improve the durability, flexibility, and tear resistance of the gripping surface.

A refined threaded base that features a universal thread compatible with most extension poles in the U.S., including sharp points, an inverted cone shape in one end, and an extended length to ensure a secure attachment within the silicone receptacle during use.

Optional cutting attachments for handling tougher stems, further extending the device's functionality across various harvesting conditions.

Together, these contributions provide a versatile, efficient, and gentle fruit-picking tool that stands apart from existing devices. The invention addresses the need for a harvesting device that minimizes damage to produce, adapts to a range of fruit sizes and conditions, and provides secure pole attachment without compromising on ease of use or durability. These features establish the present invention as a significant improvement over prior art, offering an innovative solution for agricultural and horticultural applications.

### BRIEF DESCRIPTION OF THE DRAWINGS

FIG. 1 depicts the practical use of the harvesting device by a user. The device, mounted on a pole, is shown in action, gripping and detaching fruit from a tree. This figure highlights the intended function of the device to minimize damage to produce during harvesting and demonstrates its maneuverability and effectiveness, as originally disclosed in the provisional application.

FIG. 2 depicts the preferred embodiment of the harvesting device (1) attached to an extension pole (2). The figure shows how the device is designed to surround and grip produce (3) on a tree. The soft, tacky silicone interior, shown in cutaway view FIG. 3b. (1.1) conforms to the shape of the produce, providing a secure yet gentle grip to prevent damage. The conical-cylindrical hybrid receptacle (1) (as further described below) enables efficient gripping, and the twisting motion (2.1) allows for the easy detachment of produce from its stem, promoting damage-free harvesting as originally depicted in the provisional application.

FIG. 3A illustrates the shape of the receptacle, in a side view, initially described as cone-shaped in the provisional application. This nonprovisional application further refines the description to a conical-cylindrical hybrid, which consists of a large cylindrical section (4) transitioning into a tapered conical section (6) and ending with a smaller cylindrical section (8). The curved transitions (5 and 7) between the cylindrical and conical sections are part of the shape depicted in the original provisional drawings. The threaded insert (9), located at the base of the smaller cylindrical section, provides the method for attaching the device to a pole.

FIG. 3B is a cutaway view showing the two main components: the silicone conical-cylindrical hybrid receptacle (1) and the threaded base insert (9). This figure demonstrates how the threaded insert fits securely within the smaller cylindrical section of the silicone receptacle. The internal female thread (10) is designed to be compatible with a range of standard extension poles available in the U.S.

FIG. 3C provides a side view of the threaded insert (9), showing the cylindrical sides with embedded sharp triangular points (11). These points enhance the secure attachment of the insert within the silicone receptacle, eliminating the need for additional fastening mechanisms.

FIG. 3D offers an isometric view of the threaded base insert, highlighting the inverted cone shape (12.1) at the top and the female thread (10) extending through it.

FIG. 4 is an exploded view illustrating the assembly of the preferred embodiment, which includes the silicone receptacle (1) and the threaded base insert (9). This view clarifies how the insert fits into the receptacle. For demonstration, a threaded extension pole (2) is shown to exhibit the connection mechanism, though the pole itself is not part of the claimed invention. The assembly reflects the modular nature of the device, aligning with the core design disclosed in the provisional application, and enhanced by further details provided in this nonprovisional disclosure.

FIG. 5A shows the threaded base insert with its tapered end (12) and the sharp triangular points (11) on the outer surface of the base that anchor it into the smaller end of the silicone part.

FIG. 5B shows a cross section of the threaded base insert, revealing the threaded core (10) and the inverted cone shape at one end (12.1).

FIG. 5C shows a detail of the threaded base insert and the triangular points (11)

FIG. 6A illustrates a cut-away view of the large cylinder end of the receptacle with three material layers.

FIG. 6B provides a detailed view of the layered construction of the receptacle.

FIG. 7A illustrates an exploded view of the modular improvement of two nested inserts (17,18) and the core invention (1). Included are the screw mechanisms (19, 20) that attach the nested inserts and core invention together.

FIG. 7B shows two nested inserts (17, 18) assembled within the primary receptacle, core invention (1).

FIG. 8A illustrates the shape of the invention, and its relationship with a larger fruit before slits are cut in the large end of the device.

FIG. 8B illustrates how the device can be modified to pick larger fruit (21) by cutting slits (22) in the larger end of the device. This enables the tacky, gripping surface to spread out (23) and make contact with a larger area of the fruits exterior surface.

FIG. 9A is an exploded view of a modular rake assembly improvement. A rod (25), threaded on both ends, attaches to the invention on one end (27) and to the rake assembly (24) on the other end (26). A lock cap (28) secures the rake to the rod.

FIG. 9B illustrates the assembled rake assembly, prior to attachment to the core invention.

FIG. 9C shows a fully assembled rake assembly (24) attached to the core invention (1).

FIG. 10A illustrates a modular cutting device (30) improvement with razor blades (31).

FIG. 10B illustrates the modular cutting device mounted to the large end of the core invention (1). When the fully assembled device is twisted, the stem is caught in the blades and cut, leaving the fruit free to be lowered to the ground in the receptacle (1).

FIG. 11 illustrates a commonly sold fruit harvester which is made from wire and is known to scar and damage the fruit it picks. My invention is designed to give fruit pickers an option that gently picks fruit without damage.

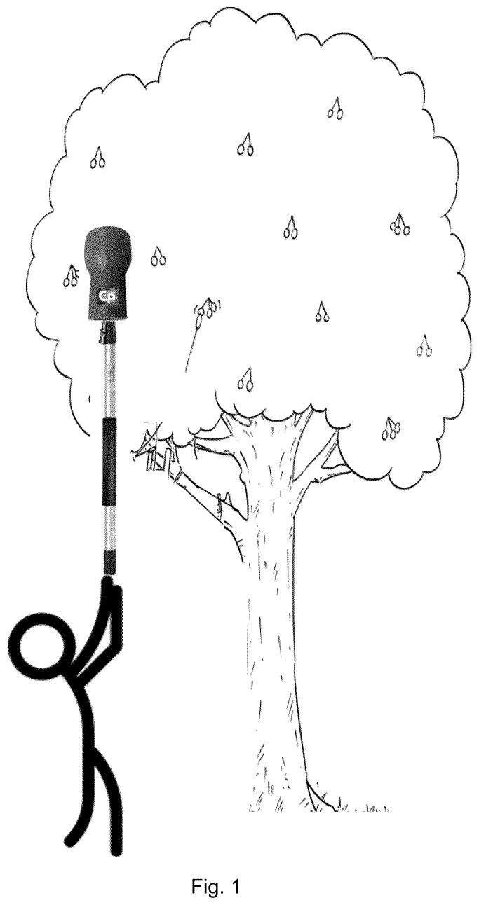

### DETAILED DESCRIPTION OF THE INVENTION

### Material Selection and Structure

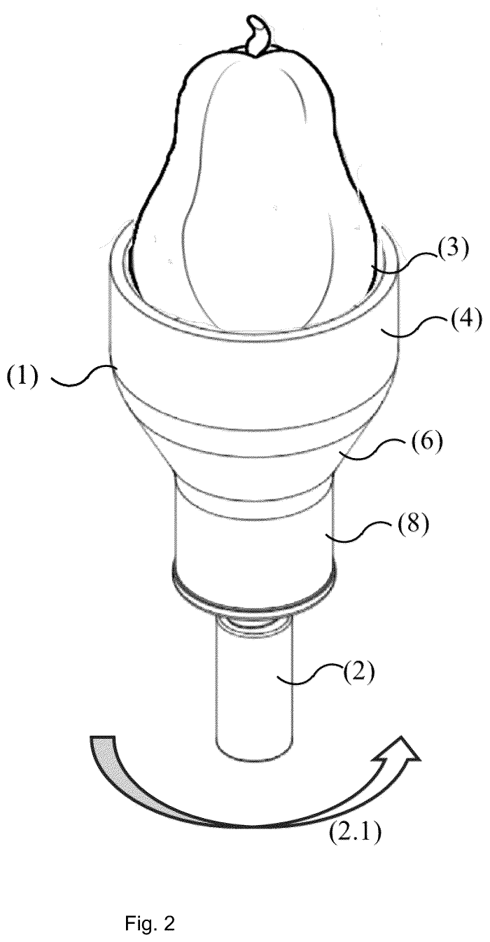

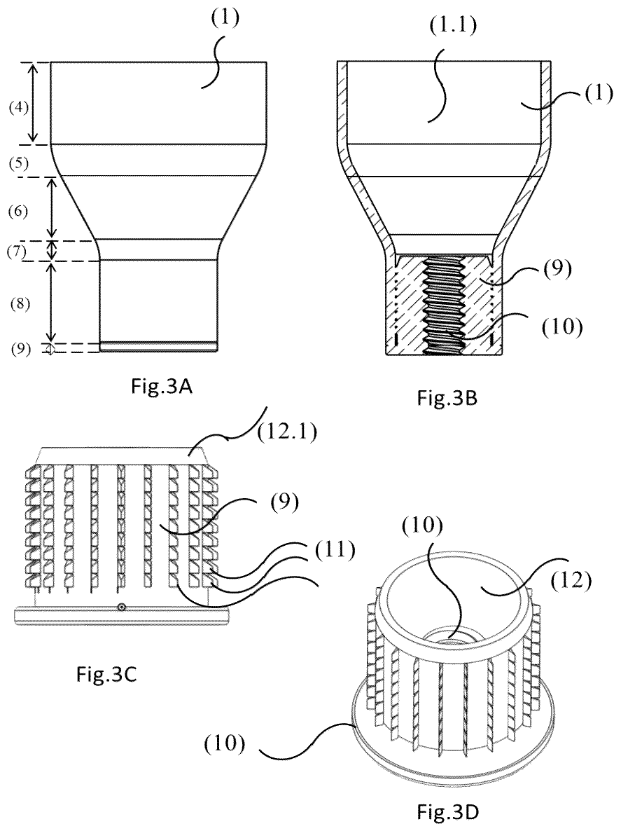

The harvesting device features a conical-cylindrical hybrid receptacle (1) as illustrated in FIGS. 2 and 3A. The receptacle is constructed from a flexible, tacky material designed to securely grip produce without causing damage. Silicone rubber was selected as the preferred material due to its sticky, adhesive properties and elasticity, allowing for gentle handling of fruits. As seen in the cut away view in FIG. 3b, the receptacle's interior surface (1.1) conforms to the shape of various agricultural products to prevent bruising or tearing.

The core shape of the receptacle, detailed in FIGS. 2 and 3A, includes a large cylindrical entry section (4) that transitions into a conical segment (6) before ending in a smaller cylindrical section (8). This shape allows the device to cradle fruits of different sizes effectively, ensuring a firm but gentle grip that facilitates harvesting without damage.

Experimentation with different materials demonstrated that the tacky nature of the silicone rubber offers a significant advantage over other tested materials by providing an adhesive, flexible grip on produce, making it ideal for harvesting soft or delicate fruits.

### Shape and Design

The conical-cylindrical hybrid receptacle (1) is designed to accommodate produce of various sizes and shapes, providing efficient and damage-free harvesting. FIG. 3A demonstrates the large cylindrical section (4) that serves as the entry point for the produce. This entry section is wide enough to cradle the fruit and guide it into the receptacle smoothly.

As depicted in FIG. 3A, the receptacle's shape transitions from the large cylindrical section (4) to a tapered conical section (6). This conical shape is essential for guiding the produce into the smaller end of the receptacle and securing it during the twisting motion required for detachment from the stem. The smooth transition curves (5 and 7) between the cylindrical and conical sections allow for a gentle grip on the produce and contribute to the adaptability of the device.

The conical section transitions into a smaller cylindrical section (8), as depicted in FIG. 3A. This final section plays a crucial role in securing the threaded base and facilitating the twisting mechanism, which effectively detaches the produce from the tree without causing damage.

The overall design allows for a single device to harvest a wide range of produce sizes, minimizing the need for multiple picking tools. The smooth shape also prevents the device from becoming tangled in branches or foliage during use, which enhances its functionality and efficiency in various harvesting conditions.

FIG. 3B illustrates a cutaway view of the receptacle, showing the continuous internal surface that facilitates a secure, damage-free grip on the produce.

### Wall Thickness and Layering

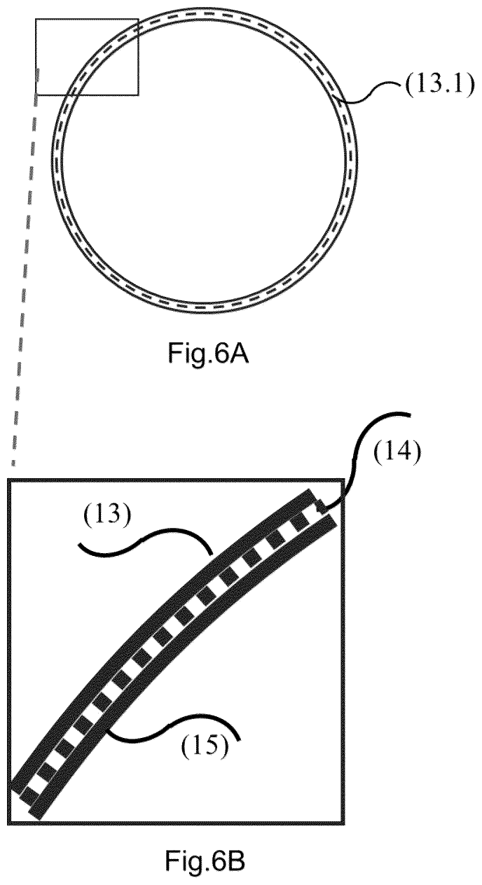

The receptacle wall thickness was designed to balance flexibility and durability for effective harvesting. FIG. 6A shows a cut away view of the large cylinder end of the receptacle with the three layers (13.1) illustrated. FIG. 6B provides a detailed view of the layered construction of the receptacle, demonstrating how the wall consists of silicone layers (13 and 15) with a fabric core (14). The wall thickness ranges from 4 to 5 mm, ensuring that the device is flexible enough to conform to the shape of the produce while being strong enough not to collapse under its weight.

The layered construction was refined through experimentation to enhance the receptacle's durability and grip performance. The inner silicone layers (15) provide the tackiness and adhesion necessary for gripping fruit, while the fabric layer (14) in between adds structural integrity and acts as a rip-stop feature. This combination prevents tearing when the receptacle is exposed to the repeated stress of harvesting various shapes and sizes of produce.

In practice, the layering method provides a balance of elasticity and strength. The inner silicone layer conforms closely to the produce's surface, ensuring a secure yet gentle grip, while the fabric core maintains the shape and prevents over-stretching. This design was selected to allow for effective twisting and pulling of produce from the stem without damaging the fruit's outer surface.

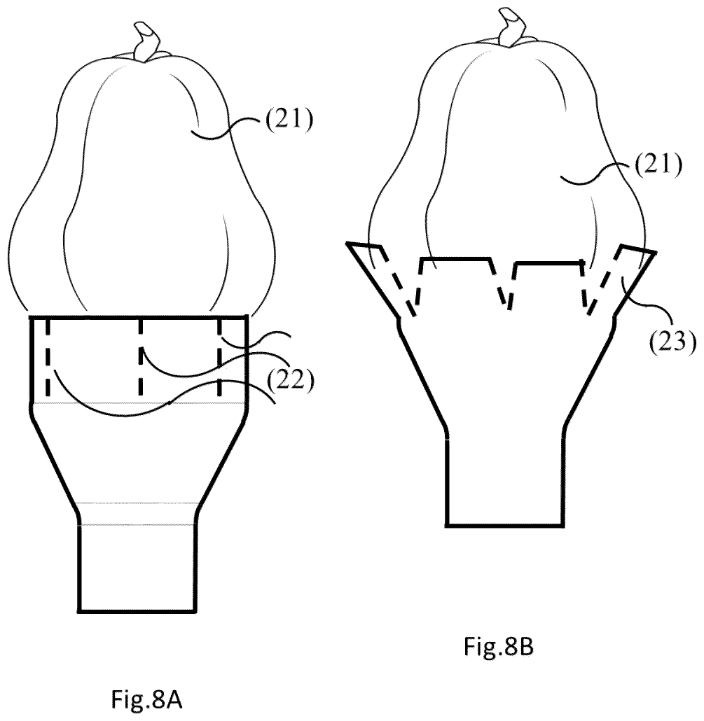

As an enhancement to the original design, a layered construction method (FIG. 6A, 6B) offers increased durability and a rip-stop effect. This additional fabric core provides resistance against tearing when slits, as seen in FIG. 8a (22), are made for larger fruits (21) that flange out FIG. 8B (23) and hold the larger fruit securely. The layered construction also enhances the stability of the threaded base that is inserted into it as seen in FIG. 3B (9).

### Threaded Base Insert and Universal Pole Connection

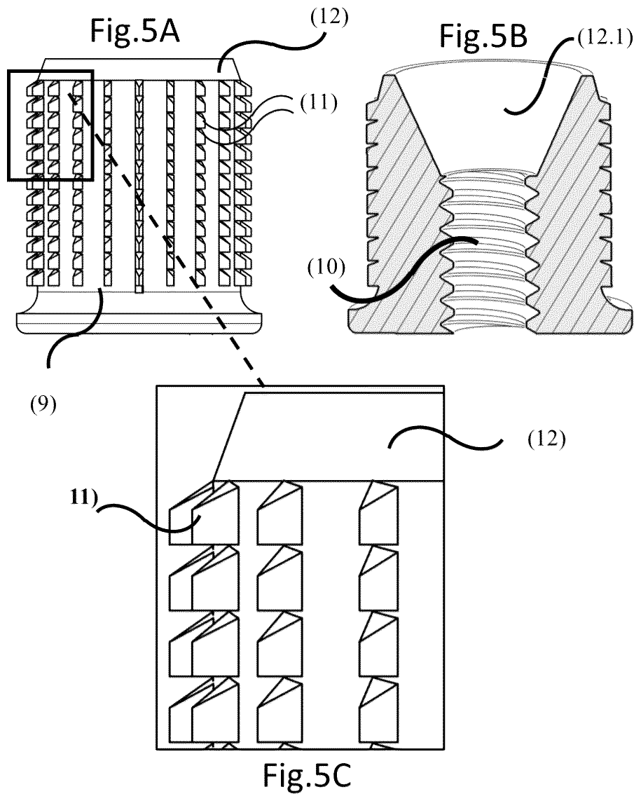

The threaded base insert (9), which is part of the provisional application, depicted in FIG. 3, is a critical component designed to securely attach the receptacle to standard U.S. extension poles. This base ensures that the device can be used to harvest produce from a range of heights effectively. The female thread (10) in FIGS. 3B and 5B, within the base is designed to be universally compatible with most standard extension poles, allowing for easy connection and use in different agricultural settings.

The extended length of the threaded base (9) provides a secure fit within the smaller cylindrical section of the receptacle, as seen in FIG. 3B (8), enhancing the stability of the connection during use. As shown in FIG. 5A and FIG. 5C, the sharp triangular points (11) on the outer surface of the base penetrate into the silicone material, in the small end of the receptacle FIG. 3A (8), creating a firm anchor and preventing the base from twisting out under pressure.

FIG. 3D offers an isometric view of the base insert, highlighting the inverted cone shape at the top (12.1) that enables smaller or pointed fruit to sit lower in the device and contact more of the interior silicone, increasing adhesion. It also transitions into the female thread (10) which can act as a connecting device for threaded inserts.

FIG. 3C (12.1) shows a tapered end. This design allows for smooth insertion into the smaller cylindrical section (8) of the receptacle during the process of inserting it.

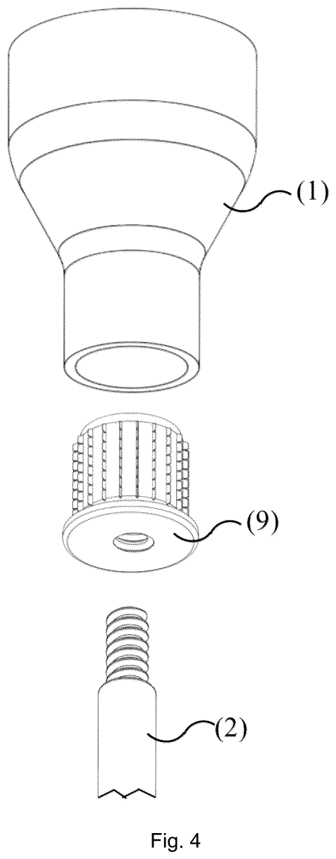

Additionally, FIG. 4 provides an exploded view of the two main components—the silicone conical-cylindrical hybrid receptacle and the threaded base insert—demonstrating the assembly process. The threaded base can be securely fastened into the receptacle by pressing the points into the silicone, and then attaching the extension pole for harvesting.

The universal pole connection allows users to use the harvesting device with their existing extension poles, eliminating the need for specialized equipment. This design makes the device more economical, as it does not require the purchase of a new pole. Additionally, the modular nature of the connection mechanism enhances versatility, making the device compatible with various pole types, lengths, and materials.

### Modularity and Adaptability

The harvesting device is inherently designed with modularity in mind as part of the core invention. This enables the receptacle to adapt to a variety of produce sizes, shapes, and harvesting conditions without damaging the fruit. The core concept of modularity allows for a versatile grip on various types of produce, making the device adaptable for different harvesting environments as originally disclosed.

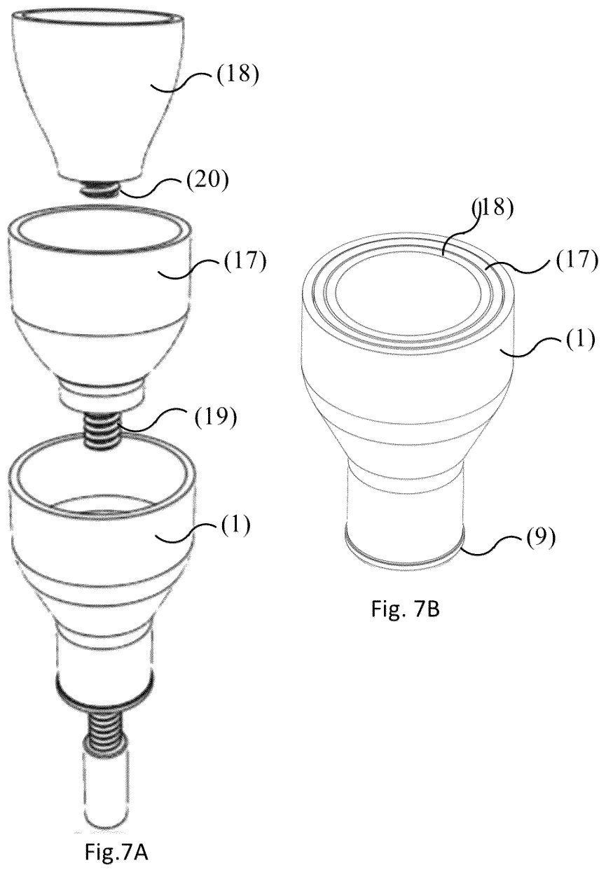

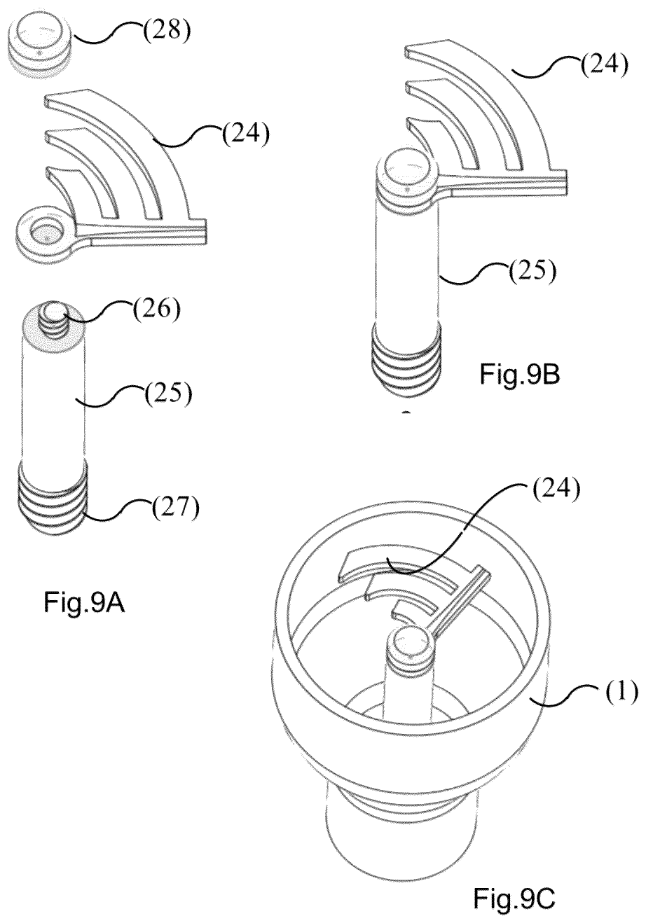

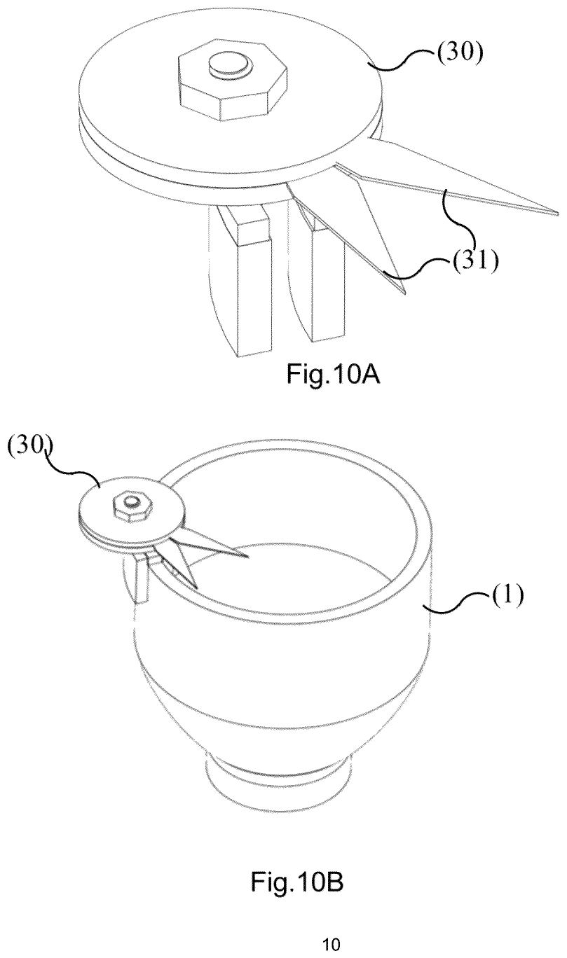

In the current application, this modularity is further enhanced by specific improvements. These refinements include nested inserts, for picking smaller fruit, as shown in the exploded view, FIGS. 7A and the assembled view, 7B, a cutting blade attachment, FIG. 10 (30) for tougher stems, and a rake insert shown in FIG. 9A (24) to aid in harvesting smaller fruits. The rake attachment is connected to the threaded base with a threaded rod (25, 26, 27) and secured by a threaded nut (28). These added features expand the adaptability of the core modular concept to cover an even broader range of harvesting scenarios.

### Experimentation and Testing Results

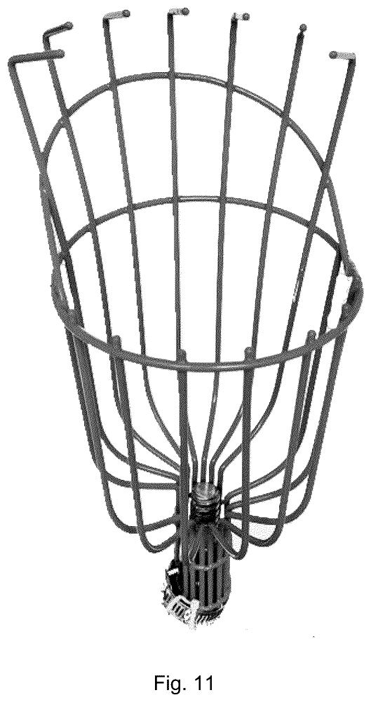

Extensive experimentation and testing were conducted to optimize the design, material, and functionality of the harvesting device. The results showed that the conical-cylindrical hybrid receptacle (1) with its tacky silicone gripping surface provided the best balance of secure grip and damage-free harvesting across a range of produce types and sizes. When compared to common wire basket pickers, FIG. 11 and other rigid pickers, this harvesting device demonstrates a significant improvement in reducing bruising, scraping, and puncturing when using the tacky, flexible silicone surface of the current invention.

Testing with fruits of varying sizes and stem lengths showed that the shape and material of the receptacle allowed it to effectively grip and twist produce from its stem without damaging the delicate skin of fruits like papayas, plums, and peaches. The Shore A 60-70 silicone rubber provided the necessary adhesion and elasticity to conform to the contours of each fruit, making it suitable for harvesting soft and delicate produce without causing harm.

Experiments with the wall thickness of 4-5 mm demonstrated that the material was flexible enough to deform around the fruit for a secure grip while maintaining enough structural integrity to prevent collapsing during use. The layered construction—with silicone-fabric-silicone layers as shown in FIG. 6A, 6B, proved to be highly durable and created a rip-stop effect, preventing tears from developing, even when slits (23) were cut for larger fruits (FIG. 8A, 8B).

The threaded base insert underwent multiple 3D-printed prototypes to determine the best shape and configuration. It was found that a longer base with sharp triangular points FIG. 5a (11) embedded within the silicone material offered the most stable connection to an extension pole and prevented the base from twisting out under lateral pressure during harvesting. FIGS. 3C, 3D depict the final design of the threaded base, which was compatible with most standard U.S. extension poles and provided reliable performance in various field conditions.

Testing of the modular features revealed that the nested inserts (FIGS. 7A, 7B) allowed for smooth resizing of the receptacle to accommodate smaller fruits or those with tightly clustered stems. The inserts were easy to drop in and remove, allowing for quick adaptation in the field. Meanwhile, the addition of a cutting blade attachment (FIG. 10) (30) and rake insert, FIG. 9A, 9B enhanced the device's ability to handle tough stems and small fruit clusters, respectively, making the device versatile for a wide range of harvesting scenarios.

The final design of the harvesting device demonstrated an improved ability to harvest fruits efficiently and gently compared to existing picking tools. The secure yet gentle grip, twisting detachment, and adaptability to different fruits were found to be significantly better than conventional harvesters, as depicted in FIG. 11.

1: A harvesting device comprising:
A Conical-Cylindrical Hybrid Receptacle designed to accommodate a variety of sizes and shapes of agricultural products;
A gripping surface composed of a tacky, flexible silicone material that provides adhesion to securely yet gently grip produce; and
A threaded base with a female thread compatible with standard U.S. extension poles.

2: The harvesting device of claim 1, wherein the gripping surface retains tackiness and elasticity to facilitate a gentle, damage-free detachment of a variety of fruits without causing damage.

3: The harvesting device of claim 1, wherein the receptacle is constructed using a layered method of silicone and fabric, enhancing durability and creating a rip-stop effect to prevent tearing.

4: The harvesting device of claim 1, wherein the receptacle can be manufactured using methods including but not limited to injection molding, compression molding, extrusion molding, 3D printing, casting, dip molding, or rotational molding to achieve the necessary flexibility, adhesion, and structural integrity.

5: The harvesting device of claim 1, wherein the exterior surface of the receptacle is smooth or tapered to prevent entanglement with tree branches during harvesting.

6: The harvesting device of claim 1, further comprising modular inserts that fit within the interior surface of the receptacle to adapt the size and shape for handling smaller or differently shaped fruits.

7: The harvesting device of claim 1, wherein the threaded base includes sharp points that secure its attachment within the smaller cylindrical section of the receptacle, ensuring stability during use.

8: The harvesting device of claim 1, wherein the gripping surface is designed for easy cleaning, maintaining its tackiness and adhesion after repeated use in various environmental conditions.

9: The harvesting device of claim 1, further comprising a cutting blade attachment positioned to assist in severing produce stems.

10: The harvesting device of claim 1, wherein the tackiness of the gripping surface is enhanced by a spray-applied coating that increases the friction coefficient.

11: The harvesting device of claim 1, wherein the threaded base is interchangeable, allowing for attachment to various pole connections for different user needs.

12: The harvesting device of claim 1, further comprising a modular rake insert adapted for harvesting small fruits, wherein the rake insert includes a plurality of prongs or teeth configured to engage the stems of small fruits, such as cherries. The prongs or teeth facilitate secure gripping and twisting of the stems, enabling efficient detachment and gentle collection of the fruit without causing damage.
